(19) United States
(12) Patent Application Publication
(10) Pub. No.: US 2014/0122232 A1
(43) Pub. Date: May 1, 2014

(54) DYNAMIC ADVERTISING

(71) Applicant: MICROSOFT CORPORATION, Redmond, WA (US)

(72) Inventors: James Michael Press, Reading (GB); Arun Kumar Mehta, London (GB); Daniel Voinea, London (GB); Graham Andrew Michael Sheldon, Seattle, WA (US)

(73) Assignee: MICROSOFT CORPORATION, Redmond, WA (US)

(21) Appl. No.: 13/661,983

(22) Filed: Oct. 26, 2012

(51) Int. Cl. G06Q 30/02

(52) U.S. Cl. 705/14.54

(57) ABSTRACT

Embodiments of the present invention dynamically generate customized online advertisements. A dynamic advertisement may take the form of a paid search result. The advertisement is dynamic in the sense that all of or portions of the advertisement are generated using content from a web page operated by an entity associated with the advertisement. The web page used to generate the dynamic ad may be the entity's most responsive web page within normal search results. Embodiments of the invention use content from the most responsive web page to generate one or more dynamic ad features. Possible dynamic ad features include the title of the advertisement, a landing page of the advertisement, a caption on the advertisement, and a dynamic annotation of the advertisement.

### BACKGROUND

Advertisements are displayed on search result web pages and on other web properties. In the case of ads shown on a search results page, the advertisements are responsive to a query used to generate the search results. The advertisements may have the appearance of a search result. The advertisement could be displayed in a separate section from the search results or with the search results. In some cases, the advertisement is built using keywords related to the query.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention relate generally to generating dynamic advertisements. A dynamic advertisement may take the form of a paid search result. The advertisement is dynamic in the sense that all, or portions of, the advertisement are generated using content from a web page operated by an entity associated with the advertisement. As used herein, content may include metadata associated with the web page. The web page used to generate the dynamic ad may be the entity's most responsive web page within normal search results generated in response to a query. Embodiments of the invention use content from the most responsive web page to generate one or more dynamic ad features. Possible dynamic ad features include the title of the advertisement, a landing page of the advertisement, a caption on the advertisement, and a dynamic annotation in the advertisement.

The dynamic advertisement may be generated upon determining that criteria are satisfied for generating a dynamic advertisement. The criteria may be specified by an entity associated with the advertisement or by the advertising infrastructure. The criteria may indicate that a dynamic advertisement should be generated upon determining that the benefit derived from improved performance of the dynamic advertisement outweighs the cost incurred by generating the dynamic advertisement. Further, various criteria may prohibit the generation of a dynamic advertisement in a situation where a dynamic advertisement may have decreased effectiveness or is prohibited by the advertiser.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of a contextual advertising environment, in accordance with an embodiment of the present invention;

FIG. 3 is a diagram showing a default advertisement, in accordance with an embodiment of the present invention;

FIGS. 4-7 are diagrams showing contextual advertisements, in accordance with embodiments of the present invention;

FIG. 8 is a flow chart showing a method of generating a dynamic advertisement, in accordance with an embodiment of the present invention;

FIG. 9 is a flow chart showing a method of generating a dynamic advertisement, in accordance with an embodiment of the present invention; and

FIG. 10 is a flow chart showing a method of generating a dynamic advertisement, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate generally to generating dynamic advertisements. A dynamic advertisement may take the form of a paid search result. The advertisement is dynamic in the sense that all of, or portions of, the advertisement are generated using content from a web page operated by an entity associated with the advertisement. As used through this description, the web page content may include web page metadata as well as text and other features that are visible on the web page. The web page used to generate the dynamic ad may be the entity's most responsive web page within normal search results generated in response to a query. Embodiments of the invention use content from the most responsive web page to generate one or more dynamic ad features. Possible dynamic ad features include the title of the advertisement, a landing page of the advertisement, a caption on the advertisement, and a dynamic annotation on the advertisement.

The dynamic advertisement may be generated upon determining that criteria are satisfied for generating a dynamic advertisement. The criteria may be specified by an entity associated with the advertisement or by the advertising infrastructure. The criteria may indicate that a dynamic advertisement should be generated upon determining that the benefit derived from improved performance of the dynamic advertisement outweighs the cost incurred by generating the dynamic advertisement. Further, various criteria may prohibit the generation of a dynamic advertisement in a situation where a dynamic advertisement may have decreased effectiveness or is prohibited by the advertiser.

In one aspect, a method of generating a dynamic advertisement is provided. The method includes receiving a query. The method also includes ascertaining an entity associated with an advertisement that is responsive to the query and that directs viewers to a destination website that is related to the query. The method also comprises determining that a page from within the entity's website has more relevance to the query than other pages within the entity's website by running the query through a search engine and comparing a relevance indication generated by the search engine for the page and the other pages. The method also comprises, subsequent to receiving the query, generating a dynamic advertisement that includes an advertisement feature that is dynamically derived from content in the page, including metadata.

In another aspect, a method of generating a dynamic advertisement is provided. The method includes receiving a query and ascertaining an entity associated with an advertisement that is responsive to the query. The method further comprises determining that a dynamic advertisement is to be generated by evaluating factors associated with the query and the entity and concluding that the factors satisfy criteria used to trigger generation of the dynamic advertisement. The method further comprises determining that a page associated with the entity has more relevance to the query than other pages associated with the entity by running the query through a search engine and comparing a relevance indication generated by the search engine for the page and the other pages. The method further comprises, subsequent to receiving the query, generating a dynamic advertisement that includes an advertisement feature that is dynamically derived from content in the page. Again, content may include metadata associated with the webpage.

In another aspect, a method of generating a dynamic advertisement is provided. The method includes receiving a query and ascertaining an entity associated with an advertisement that is responsive to the query. The method also comprises determining that a web page associated with the entity has more relevance to the query than other web pages associated with the entity by running the query through a search engine and comparing a relevance indication generated by the search engine for the web page and the other web pages. The method also comprises, subsequent to receiving the query, generating a dynamic advertisement by modifying an advertisement feature in the entity's default advertisement with an updated advertising feature that is dynamically derived from content in the web page.

Having briefly described an overview of embodiments of the invention, an exemplary operating environment suitable for use in implementing embodiments of the invention is described below.

### EXEMPLARY OPERATING ENVIRONMENT

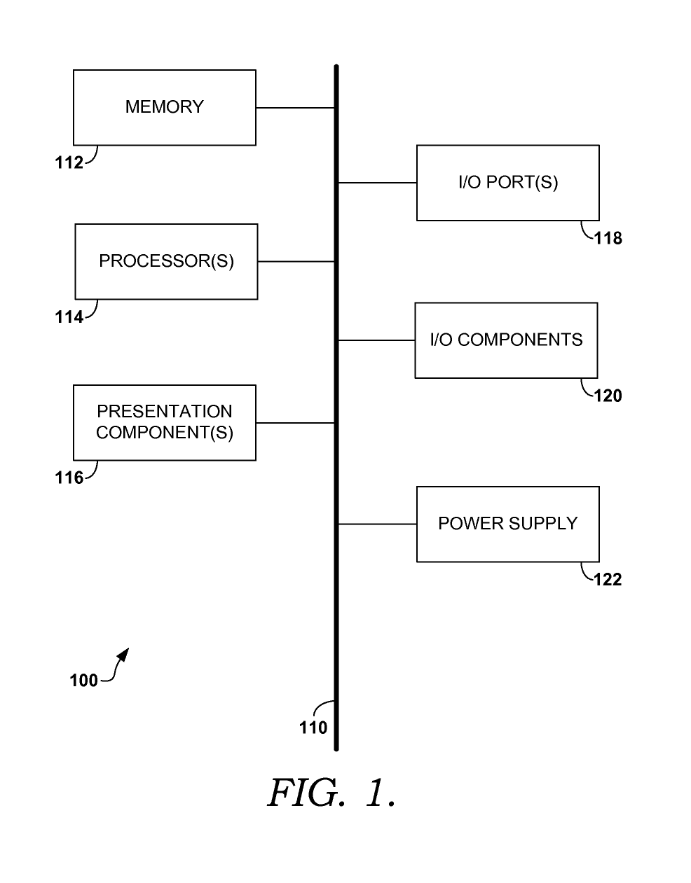

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and nonremovable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Online Advertising Environment

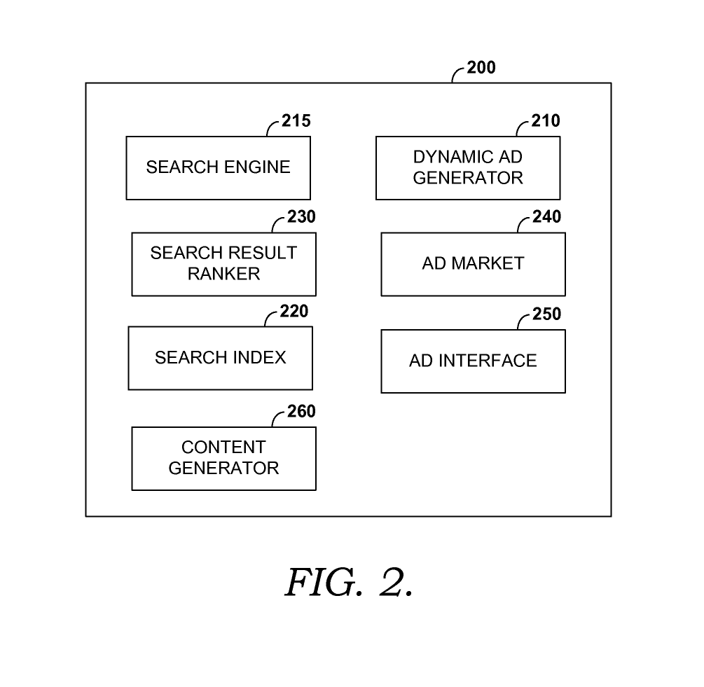

Turning now to FIG. 2, a contextual advertising environment 200 is shown, in accordance with an embodiment of the present invention. The contextual advertising environment 200 includes a dynamic ad generator 210, a search engine 215, a search index 220, a search result ranker 230, an advertising market 240, an advertisement interface 250, and a content generator 260. Environment 200 is merely an example of one suitable architecture and is not intended to suggest any limitation as to the scope of the use or functionality of the present invention. Neither should the environment 200 be interpreted as having any dependency or requirement related to any single component or combination of components illustrated therein. In one embodiment, all of the components in environment 200 are part of an online search engine that generates search results in response to a query.

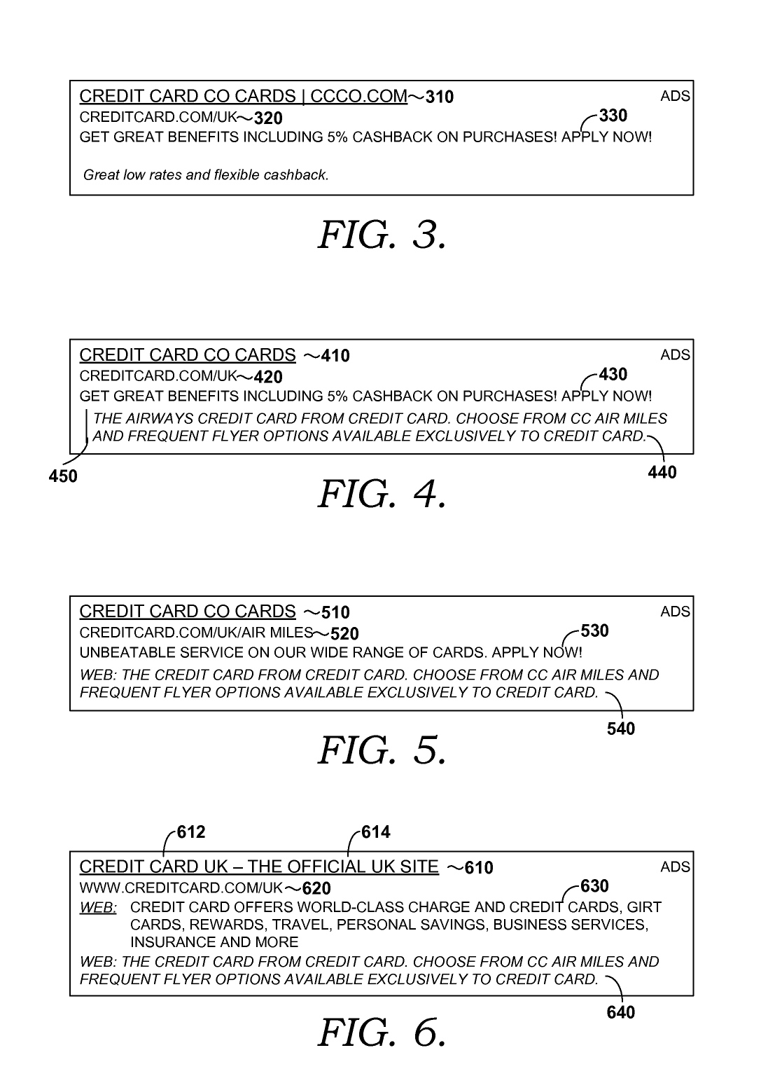

The dynamic ad generator 210 generates dynamic advertisements. Examples of dynamic advertisements will be explained in more detail subsequently with reference to FIGS. 3-7. In general, a dynamic advertisement is generated from content on an entity's web pages that is most responsive to the query. The entity is a company, person, or other organization. The entity has one or more websites or a single website with multiple pages. The entity is also associated with an advertisement. For example, if a sporting goods entity has offered to pay for display of an advertisement in response to a search query for “baseball gloves,” then a determination is made as to which page within the sporting good entity's website is most responsive to “baseball gloves.” In one embodiment, the most responsive page is the one with the most responsive search result returned in response to “baseball gloves.” The search results may be generated by a search engine producing search results to be displayed with the advertisement. Content is taken from the most responsive page to generate the dynamic ad.

Factors other than just the query may be used to determine which page is the most responsive. For example, information known about the user submitting the query may be combined with the query information to determine the most relevant web page. For example, if a user is known to be a fan of a particular baseball team then a web page with baseball gloves decorated with logos from that baseball team may be the most relevant web page.

In one embodiment, the most relevant web page is the most responsive web page returned in response to the search query that is also associated with the entity. In another embodiment, the most responsive web page is the most responsive web page returned in response to the search result, excluding the entity's home page. Excluding the home page may be valuable because factors such as traffic and links may elevate the home page above more relevant web pages using a normal ranking method. Since it is already determined that the advertisement will be modified using a web page associated with the entity, excluding the home page improves the probability that the most relevant website will be selected using the normal search results ranker.

The dynamic ad generator 210 may evaluate various criteria to determine whether a dynamic advertisement is generated. As mentioned, it may not always be advisable to generate a dynamic ad. For example, various intents associated with the query may not lend themselves to generating a dynamic advertisement. In addition, advertisements associated with low monetization keywords and categories may not be worth dynamically modifying.

In addition to the overall performance of the advertisement, generating dynamic advertisements, which draw content from a landing web page, may be problematic in certain circumstances. For example, when the search results or intent of the search query appears to be adult content, it may not be desirable to generate a dynamic ad that may inadvertently extract offensive material and put it in an ad that is displayed to the user. Another example of an intent that will not result in a dynamic ad in some circumstances is a navigation intent. A navigation intent is a desire to navigate to a particular website.

The dynamic ad generator 210 generates the dynamic advertisement by deriving advertisement features from content on the top-ranked web page. Again, as used herein, the top-ranked page is calculated using a search and relevance indication, such as a relevance rank or score. A dynamic URL is one ad feature that may be updated. In one embodiment, a template advertisement or a default advertisement is modified to include the URL from the top-ranked web page. This may also be described as a landing page. The default advertisement or template advertisement may include a URL for the entity's home page or other page. This may be replaced by a URL for the most responsive web page. This is an improvement since the advertisement is linked to the most relevant web page, which increases the probability that the user buys a product on the web page. This may increase the conversion rate of the advertisement.

In another example, a dynamic annotation or caption may be generated by the dynamic ad generator 210. A caption may be a single line generated to summarize a web page. This may be generated through a caption generator that is used to generate captions on search results. In one embodiment, the exact same caption generator that generates captions on search results is used to generate a dynamic caption for the advertisement. Because the dynamic advertisement is based on the most relevant web page, the generic caption that was previously on the advertisement may be replaced with a caption that is more relevant to the user. A more relevant caption may draw the user's attention and make it more likely that the user is going to click on the advertisement and navigate to the relevant web page linked to the advertisement.

The dynamic annotation is similar to the caption. The dynamic annotation is derived from content on the web page and may include a relevant sentence or two describing or attempting to answer the user's query. The dynamic annotation may also make it more likely that the user clicks on the advertisement. In one embodiment, the dynamic annotation is generated using metadata from the page. The metadata may be editorial content added to the page for the purpose of appearing in an advertisement or search result. For example, the editorial content may include a deep link within a website that could form part of an annotation.

Similarly, a title for the advertisement may be generated from the title of the web page or another method of generating a title for search results. The title for the web page in some cases is specified by metadata associated with the web page.

In one embodiment, the dynamic advertisement generator 210 first evaluates whether each aspect of an advertisement should be dynamically generated. An advertiser may specify whether various portions of an advertisement may be dynamically generated. For example, the advertiser may want the same title to appear on all of its advertisements for branding purposes but would be open to having the landing page, caption, or dynamic annotation dynamically generated. The advertisement may set these criteria at different levels of granularity. Other factors may also be considered in making this determination. For example, it may be determined that for certain advertisers or categories of advertisements that generating a dynamic caption does not improve advertisement performance significantly and what is most helpful is generating a detailed dynamic annotation that provides specific product information and even pricing. In these circumstances, only the URL linking to a particular page and the dynamic annotation may be updated, while a title and caption are left in place.

In addition, advertisements may also include various icons or images that could be updated. For example, an advertisement could include a picture of a particular product. In one embodiment, this page is dynamically derived from a picture on the website. Dynamically deriving the content may comprise generating a thumbnail from an image displayed on the web page.

The search engine 215 is associated with a website that receives search queries and presents search results that are responsive to the search query. The search engine 215 is also associated with one or more advertising markets by which advertisements are displayed along with the search results. The advertising campaign may take the form of an online advertising auction. An online advertising auction allows entities to bid on advertising space. The auction allows the entity to specify different bid prices for different keywords that are relevant to the query. Other factors, such as user characteristics, can affect the bid price. In one embodiment, the bids are submitted in a cost-per-click basis. In other words, the advertiser will pay a certain amount if a user clicks on a displayed advertisement. Advertising auctions can be complex and the highest bidder does not necessarily win. For example, the entity's previous ad performance may be considered to determine the likelihood that a user would actually click on the advertisement. This may be combined with the bid price to select the entity that has the highest probability of generating the highest revenue for the owner of the ad space. Embodiments of the invention may work with a variety of different online auctions.

The search index 220 includes an index of various web pages and websites. The search index 220 may be generated by web crawlers that evaluate various web pages and extract content to be included in the index. The search engine 215 uses the search index 220 to determine which websites are responsive to a particular query. In addition, the search index may include various website metrics that are used to determine a particular page's relevance. For example, a total amount of traffic to a particular website as well links to a website may be stored in the search index 220. The search index 220 may be generally described as a collection of information regarding various websites. The search index 220 is not necessarily a particular file or a single index. The search index 220 could include numerous different indexes for various purposes. The search engine 215 could access various indexes depending on search criteria and other metrics, for example an intent into which the query is classified.

The search result ranker 230 ranks responsive search results in terms of relevance. In general, the idea is to present the user that submitted the query with search results that are the most relevant. There are various methods for determining relevance, and all of them may be used in embodiments of the present invention. In one embodiment, dynamic advertisements are generated using the web page that the search results ranker 230 uses or determines is the most relevant. In another embodiment, dynamic advertisements are generated using a different ranking mechanism from what is used to determine the overall most relevant web pages. Accordingly, the search results ranker 230 may include different algorithms for ranking relevance and apply them in different situations. For example, one algorithm could be used to rank the search results presented in response to the query and another algorithm could be used to rank the most relevant web page within a website associated with an entity.

The ad market 240 uses various criteria to determine which entities are able to display advertisements on a search results web page. As mentioned, the ad market 240 could run an online advertising auction. For the purposes of this invention, the ad market 240 determines that at least one entity has offered to display an advertisement in response to a query received by the search engine 215. The ad market 240 may also store a default advertisement that is to be displayed in response to the keywords. In addition, the advertising market 240 may save various performance information that is used by the dynamic ad generator 210 to determine whether a default advertisement should be changed into a dynamic advertisement. Or, alternatively whether a dynamic advertisement should be generated at all. The ad market 240 stores various advertiser preferences related to dynamic content generation. Alternatively, these advertising preferences could be stored elsewhere and retrieved by the dynamic ad generator 210 to determine whether to generate dynamic advertisement.

The ad interface 250 generates an advertising interface through which the advertiser can specify dynamic advertising criteria. Most basically, the advertiser may specify whether or not they authorize dynamic advertisements to be generated. Another interface option is to allow the advertiser to request that all of its advertisements be dynamically generated or a portion of its advertisements be dynamically generated. These criteria may be broken down at various levels of granularity. For example, the advertiser may specify that advertisements associated with a particular set of keywords are allowed to be dynamic or are required to be dynamic. Similarly, advertisements associated with a different set of keywords may be forbidden to be dynamically generated.

As part of the interface, various performance metrics related to the performance of dynamically generated advertisements may be shown to the advertiser. These metrics may display the various performance levels for dynamic advertisements generated on behalf of the advertiser as well as dynamic advertisement performance for various keywords regardless of the advertiser. Further, various simulations may be provided to estimate the improved performance that an advertiser could expect if it authorizes the advertisements to be dynamic. The estimate may be generated by extrapolating the performance difference between other advertisers' default ads versus the performance obtained by those same advertisers' dynamically generated ads. When information is available, the different levels of performance between a specific advertiser's default and dynamic ads may also be used to calculate an expected performance.

The content generator 260 generates captions and other content for a dynamic advertisement. The same content generator 260 that generates captions for a dynamic advertisement may also be used to generate captions for a search result. A content generator 260 evaluates content and metadata associated with a particular web page and extracts snippets that may be organized into a caption, dynamic annotation, or title.

### Dynamic Ad Examples

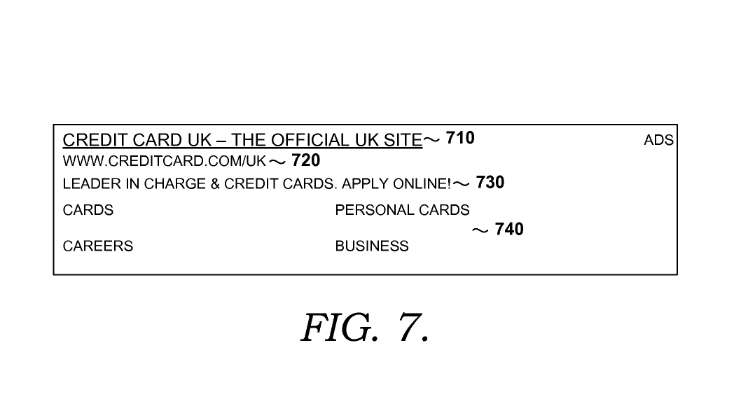

Turning now to FIG. 3, an exemplary default advertisement 300 is shown, in accordance with an embodiment of the present invention. The advertisement 300 is a paid search ad that has not been dynamically modified. The purpose of advertisement 300 is to illustrate ad features and to contrast the default ad 300 with the dynamic ads of FIGS. 4-7. The advertisement 300 includes a title 310. The title appears at the top of the advertisement 300. The main title describes the name of a company, a credit card company, and identifies the company's online presence by listing its main domain name.

Underneath the title 310, the landing page 320 that the user will navigate to upon clicking on the advertisement 300 is shown. Advertisement 300 also includes a caption 330 having several lines of text.

Turning now to FIG. 4, an exemplary dynamic advertisement 400 is shown, in accordance with an embodiment of the present invention. Dynamic advertisement 400 includes a title 410, a landing page 420, a caption 430, and a dynamic annotation 440. Bar 450 communicates to the user that the provenance of the content in the dynamic annotation 440 is the linked UK home page. The dynamic annotation 440 may also be set apart using a different font, color, or other indication. Setting the dynamic annotation 440 apart using a bar 450 or other mechanism draws the user's attention to the detailed information in the dynamic annotation 440.

Turning now to FIG. 5, a dynamic advertisement 500 including a dynamically generated caption 530 is shown, in accordance with an embodiment of the present invention. Dynamic advertisement 500 includes the standard title 510, a dynamic landing page 520, with a dynamic caption 530, and a dynamic annotation 540. The dynamic landing page 520 is for the air miles page. The dynamic caption 530 recites “unbeatable service on our wide range of cards! Apply now!” As can be seen, the caption 530 is different from the caption on the other advertisements shown in FIGS. 3 and 4. Advertisement 500 includes dynamic annotation 540. Dynamic annotation 540 includes “web” before the annotation to indicate its provenance and dynamic nature.

Turning now to FIG. 6, a dynamic advertisement 600 includes a dynamic title 610, including a dynamic main title 612 and a dynamic subtitle 614. The standard landing page 620 is included along with a dynamic caption 630 and a dynamic annotation 640. The “web:” and offsetting of the dynamic caption 630 indicates the provenance of the caption is the landing page. This gives the user confidence that the caption accurately describes the landing page. The dynamic annotation 640 is provided, as in FIG. 5.

Turning now to FIG. 7, a dynamic advertisement 700 including the same dynamic title 710 from FIG. 6 is included. The advertisement includes a standard landing page 720 along with the dynamic caption 730 and a dynamic annotation 740. The dynamic annotation 740 includes deep content from web page that may be derived from metadata. The dynamic caption 740 lists four different types of cards offered on the landing page.

### Generating a Dynamic Advertisement

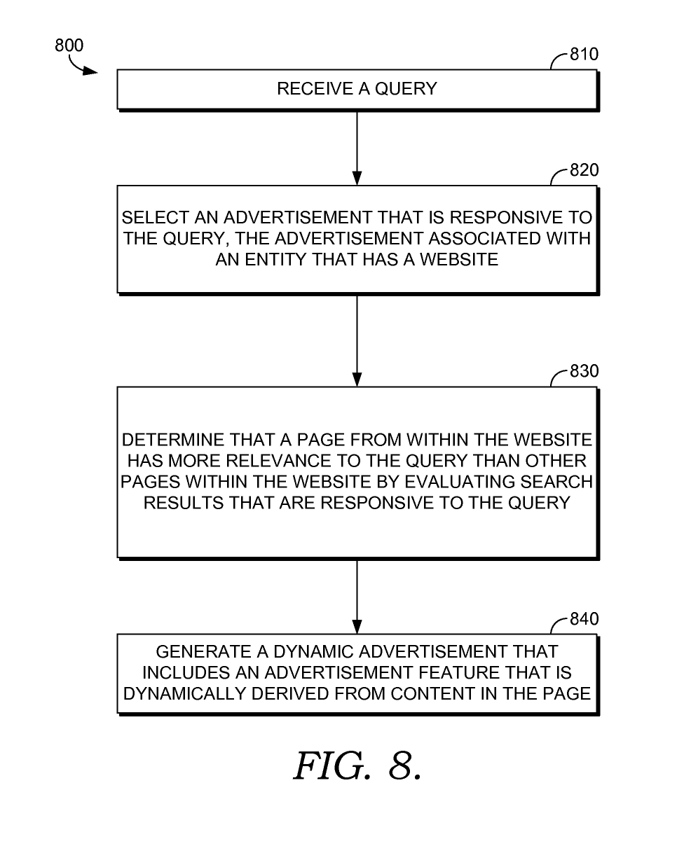

Turning now to FIG. 8, a method 800 of generating a dynamic advertisement is shown, in accordance with an embodiment of the present invention. Exemplary dynamic advertisements have been explained previously with reference to FIGS. 3-7. However, embodiments of the present invention are not limited by the illustrations given previously. A dynamic advertisement may be generated or modified using content taken, or derived from or associated with, an entity's most responsive web page within search results. The modification may occur after a query is received.

At step 810, a query is received. The query may be received through an online search page, such as those provided by known search engines. In one embodiment, the query is received from a search related application. The application may be running on a mobile device. When received from another application, the query may be pre-processed into keywords or words associated with the keywords. The query may be a keyword query or a natural language query. Other types of queries are also possible. A search engine may generate a search results in response to the query. The search results page has space for one or more advertisements.

At step 820, an advertisement responsive to the query is selected. The advertisements may take the form of a paid search result. The advertisement may have been selected for display with search results. Advertisements may be selected by a search engine through an online auction or advertising index. For example, advertisers may place bids for its advertisement to be shown when designated keywords occur in the query. Each advertisement is associated with an entity. The associated entity may be designated within the advertising auction and ascertained by analyzing auction data, such as metadata associated with the advertisement. In another embodiment, the entity is ascertained by navigating to the URL associated with the advertisement and analyzing the page to extract the entity. The advertisement may direct viewers to a destination website that may be related to the query.

The entity is a company, person, or other organization. The entity has one or more websites or a single website with multiple pages. The entity is also associated with an advertisement. As used herein, the entity may be the entity that is offering a good or service through the advertisement. The entity has one or more websites that comprise one or more web pages describing goods or services associated with the entity.

A website may include a home page and a hierarchy of child pages associated with various subdomains. In some embodiments, the home page is associated with a web domain and the child pages are associated with various subdomains. A website could have thousands of pages devoted to various products and services offered by the entity. Social networking sites may have thousands of different pages associated with different users. Various news information and entertainment sites may have thousands of different web pages, each associated with a different article, or other content. In each of these cases, the entity may choose to advertise. The purpose of the advertisement to lead viewers to a destination website. For example, the user may click on an advertisement and follow a link to a destination website.

The entity may have offered to pay for the display of an advertisement in an online advertising auction. There are numerous ways to run an online auction, for example several advertisements may be displayed in various positions on a web page based on the amount offered. Method 800 could be repeated for each advertisement that has participated in the auction. In one embodiment, only advertisements that have the potential for display on the page, because there is both room and they are one of the high bidders, are evaluated. In another embodiment, only a threshold number of advertisements and associated entities are evaluated. Either way, at the conclusion of step 820, an advertisement associated with an entity is selected. As a result, the entity is determined to have an interest in displaying an advertisement in response to the query. In some cases, the entity may have specifically designated a particular advertisement for display in response to the query. This advertisement may be related to the query based on keywords associated with both the query and the advertisement or through some other mechanism.

At step 830, a page from within the entity's website is determined to have more relevance to the query than other pages within the entity's website. This determination is made by evaluating search results that are responsive to the search query. For example, a search engine may produce a set of search results each having a responsiveness indication, such as a rank or score. Search results within the set of search results are determined to be associated with the entity. Of these, the one with the highest rank or score is determined to be the most relevant. The search engine may be the same search engine that is used to generate search results in response to the search query. These search results may be displayed in conjunction with the advertisement. The relevance indication may be a comparative rank of the various pages within the website that are responsive to the query. In other words, the page selected may be the top-ranked web page among the web pages within the entity's website. Since this web page is selected for the purpose of generating a dynamic advertisement for the entity, the website and web page are associated with the entity. In one embodiment, responsive web pages that are not associated with entity are ignored.

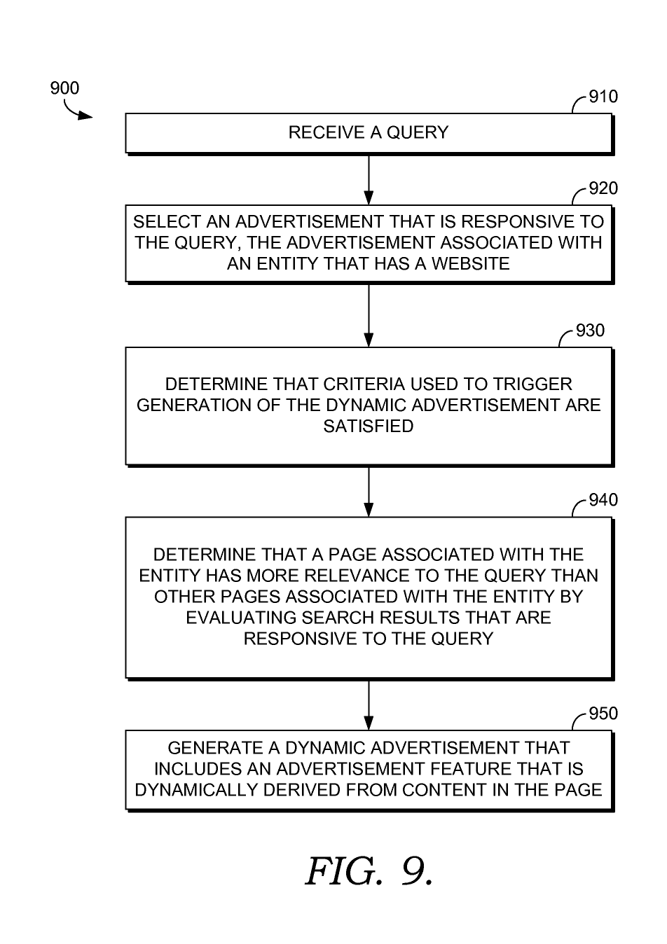

At step 840, a dynamic advertisement that includes an advertisement feature that is dynamically derived from the content in the page is generated. Step 840, is performed after the query is received. Again, the page in question is the most responsive page in terms of relevance. In one embodiment, the dynamic advertisement entirely comprises content dynamically derived from the page. The content could be metadata, text, images, or other items on the page. For example, a paid search result advertisement could have a title, landing page, caption, and dynamic annotation all dynamically derived from the page. In one embodiment, the dynamic advertisement is generated on demand when various rules or criteria are satisfied. These criteria will be explained in more detail with reference to FIG. 9.

In another embodiment, the dynamic advertisement comprises subject matter or content from a default advertisement along with advertising features that have been modified or added from content that is dynamically derived from the content of the page. Again, using the paid search result example, the dynamic advertisement could have a default title and caption along with a dynamic landing page and a dynamic annotation. In another embodiment, the dynamic advertisement has all of the content from the default advertisement plus additional details that have been added to the default advertisement. For example, the additional details could include price or product information for a product specifically indicated within the search query. As mentioned, the dynamic content may be set apart visually to indicate its provenance from the top-ranked web page.

Turning now to FIG. 9, a method 900 of generating a dynamic advertisement is shown, in accordance with an embodiment of the present invention. Various dynamic advertisements have been illustrated previously. At step 910, a query is received. The query may be received by online search engine. At step 920, an advertisement is selected. The advertisement is associated with an entity. The entity is a company, person, organization that has a website. The website may be associated with the advertisement through a link within the advertisement. Other methods of associating an entity with the website are also possible. As mentioned previously, the advertisement and entity may be ascertained through the results of an advertising auction. In one embodiment, the entity is associated with the highest bid for an advertising spot available on a search results web page. Note that the highest bid could be associated with an entity with no default advertisement designated. In this case, the entire advertisement could be dynamically generated. Embodiments of the present invention are not limited to the entity associated with the highest bid. Further, method 900 could be repeated for each entity or advertisement that wins an available advertising spot that is shown in response to the query.

At step 930, a determination is made that criteria used to trigger generation of the dynamic advertisement are satisfied. In other words, authorization to generate a dynamic advertisement is granted.

Step 930 allows a dynamic advertisement to be generated in designated circumstances. For example, the advertisement may not be dynamically generated when the query is classified into one or more intents. In general, intents associated with a low monetization may not trigger generation of the dynamic advertisement. Conversely, intents associated with highly monetizable intent categories will satisfy the criteria used to trigger generation. An example of classification intents that do not trigger the generation of a dynamic advertisement in some situations is a navigation intent. A navigation intent indicates the user is looking for a specific website. For example, the query may be part of a URL for a particular website. Another example of an intent is seeking information for blocked categories. Blocked categories include those that may be illegal or offensive. For example, an intent to seek adult content may cause the dynamic advertisement not to be generated.

Other sets of criteria are specified by the entity. In one embodiment, an advertising interface allows the entity to specify whether they want dynamic advertisements to be generated on its behalf as well as circumstances in which the generation should proceed. For example, the advertiser may specify that dynamic advertisements are not to be generated for specific keywords. An advertiser could also specify that a dynamic advertisement is to be generated in all circumstances.

In addition to entity requirements and query classification, the overall performance of the advertisement may be evaluated to determine whether the advertisement's performance is likely to improve if it is dynamically generated. The performance of dynamic advertisements versus the performance of default advertisements, which are those submitted by the entity and not modified based on the landing page, may be tracked over time and compared. When the performance of dynamically generated advertisements does not improve, or does not improve above a threshold for a particular entity or advertising category, then the generation of dynamic advertisement maybe skipped. On the other hand, when it is determined that a dynamic advertisement performs above a threshold better than a default advertisement, then the dynamic advertisement may be generated. So long as it is not forbidden by the entity, a dynamic advertisement may be generated when performance is determined to increase.

At step 940, a page from within the entity's website is determined to have more relevance to the query than other pages associated with the entity. This determination is made by evaluating by evaluating search results that are responsive to the query. In one embodiment, the search results are geared to rank the most specific web page higher than less specific web pages for the entity. This may be a different algorithm from what is used to generate typical search results. Specifically, the general algorithm may weigh heavily the traffic to a particular web page and links to the web page. A home page may score higher than other pages within the website based on these criteria. However, because the intent is to look for the most relevant web page within a website that has already been determined by virtue of its association with the entity, these other factors may be given less weight. Further, in some cases the home page for the website is excluded entirely. Thus, in one embodiment the search results favor web pages within the website that are lower in the website's overall hierarchy. This is just one embodiment, and the rank within the normal search engine results displayed in response to the query may also be used.

At step 950, subsequent to receiving the query, a dynamic advertisement is generated. The dynamic advertisement includes an advertisement feature that is dynamically derived from content in the page. Examples of dynamically derived content have been explained previously.

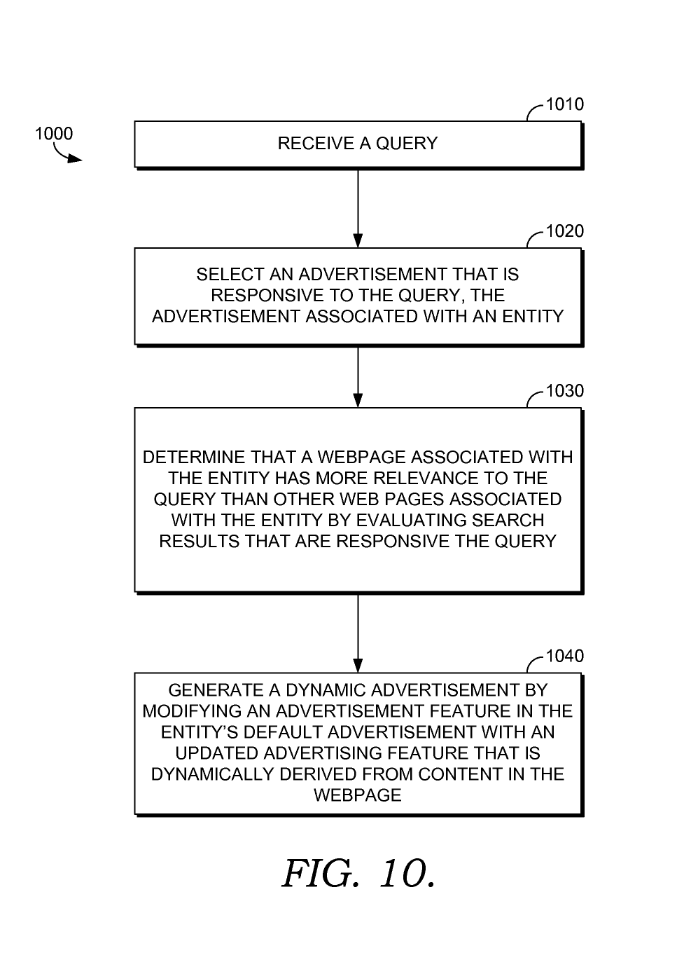

Turning now to FIG. 10, a method of generating a dynamic advertisement is shown, in accordance with an embodiment of the present invention. At step 1010, a query is received. As mentioned, the query may be submitted to an online search engine. At step 1020, an advertisement responsive to the query is selected. The advertisement is associated with an entity. The advertisement may direct viewers to a destination website that is related to the query. For example, the advertisement may be linked to the entity's home page. The advertisement may also be linked to a specific page within the company's website associated with a product that is responsive to the query.

At step 1030, a page within the entity's website is determined to have more relevance to the query than other pages associated with the entity. This determination is made by evaluating search results that are responsive the query.

At step 1040, a dynamic advertisement is generated by modifying an advertisement feature in the entity's default advertisement with an updated advertisement feature that is dynamically derived from content in the web page. This results in a hybrid advertisement that includes content from the default ad along with updated content. As mentioned previously, the dynamic ad in this case may include all of the content from the default ad with a dynamic annotation added. In another embodiment, parts of the default advertisement are replaced with dynamically generated advertisement content. For example, a dynamically generated title may be substituted for the default title. In addition, a default landing page, such as the entity's home page may be replaced with the URL for the most responsive page. This links the advertisement directly to the page determined to be most responsive to the query.

In one embodiment, rules are evaluated before each part of an advertisement is dynamically generated. The rules may be specified by the advertiser to permit parts of the advertisement to be dynamically generated under all or designated circumstances. Other rules may apply generally across advertisers. These rules may be intended to put the resources required to generate a dynamic advertisement to efficient use.

In one embodiment, all steps in methods 800, 900, and 1000 are performed by an online search engine.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon that when executed by a computing device perform a method of generating a dynamic advertisement, the method comprising:
receiving a query;
selecting an advertisement that is responsive to the query, the advertisement associated with an entity that has a website;
determining that a page from within the website has more relevance to the query than other pages within the website by evaluating search results that are responsive to the query; and
generating a dynamic advertisement that includes an advertisement feature that is dynamically derived from content in the page.

2. The media of claim 1, wherein the dynamic advertisement has an appearance similar to a search result.

3. The media of claim 2, wherein the advertisement feature in the dynamic advertisement is a uniform resource locator (“URL”) for the page.

4. The media of claim 2, wherein the advertisement feature in the dynamic advertisement is a dynamic annotation derived from content associated with the page, the dynamic annotation comprising details describing a service or product offered for sale on the page.

5. The media of claim 2, wherein the advertisement feature in the dynamic advertisement is a dynamic caption derived from content associated with the page.

6. The media of claim 2, wherein the advertisement feature in the dynamic advertisement is a dynamic title based on a title associated with the page.

7. The media of claim 1, wherein the a responsiveness indication generated by the search engine is used to determine that the page has more relevance to the query than other pages associated with the query.

8. A method of generating a dynamic advertisement, the method comprising:
receiving a query;
selecting an advertisement that is responsive to the query, the advertisement associated with an entity;
determining that criteria used to trigger generation of the dynamic advertisement are satisfied;
determining that a page associated with the entity has more relevance to the query than other pages associated with the entity by evaluating search results that are responsive to the query; and
generating the dynamic advertisement that includes an advertisement feature that is dynamically derived from content in the page.

9. The method of claim 8, wherein the criteria comprises an expectation of improved that is satisfied when historical advertising performance information indicates the dynamic advertisement has above a threshold probability of producing the improved advertising performance.

10. The method of claim 8, wherein the criteria comprises an intent classification given the search query.

11. The method of claim 10, wherein the intent classification to navigate to a particular web page does not satisfy the criteria.

12. The method of claim 8, wherein the criteria comprises instructions provided by the entity explaining when the dynamic advertisement is to be generated.

13. The method of claim 12, wherein the method further comprises outputting for display an advertising campaign manager interface having interface controls for the entity to input the instructions.

14. The method of claim 8, wherein the content in the page is metadata associated with page.

15. A method of generating a dynamic advertisement, the method comprising:
receiving a query;
selecting an advertisement that is responsive to the query, the advertisement associated with an entity;
determining that a webpage associated with the entity has more relevance to the query than other web pages associated with the entity by evaluating search results that are responsive the query; and
generating a dynamic advertisement by modifying an advertisement feature in the entity's default advertisement with an updated advertising feature that is dynamically derived from content in the web page.

16. The method of claim 15, wherein the advertisement feature is one or more of a title, a caption, a landing page, and a dynamic annotation.

17. The method of claim 15, wherein the dynamic advertisement comprises one or more advertising features from the default advertisement and the updated advertising feature.

18. The method of claim 15, wherein the dynamic advertisement comprises a display characteristic that indicates that the updated advertising feature is derived from the web page.

19. The method of claim 15, wherein the dynamic advertisement comprises deep content from the web page describing a specific product or service provided through the web page.

20. The method of claim 15, wherein the method further comprises determining that a particular advertising feature in the default advertisement is to be updated by evaluating factors associated with the query and the entity and concluding that the factors satisfy criteria used to trigger generation of the dynamic advertisement with respect of the particular advertising feature.
